(19) United States
(12) Patent Application Publication
(10) Pub. No.: US 2026/0367643 A1
(43) Pub. Date: Nov. 19, 2026

(54) PATH PLANNING AND NAVIGATING OFF-ROAD EQUIPMENT USING BOUNDARIES, OBSTACLES, AND RECORDED COVERAGE DATA

(71) Applicant: Deere & Company, Moline, IL (US)

(72) Inventors: David August JOHNSON, Durham, NC (US); Jeffrey S. PUHALLA, Hawley, MN (US); Eric EDSTROM, Urbandale, IA (US); Qiang R. LIU, Urbandale, IA (US); Gregory L. PETER, Raleigh, NC (US)

(21) Appl. No.: 19/212,266

(22) Filed: May 19, 2025

(51) Int. Cl. G05D 1/646; G05D 1/246; G05D 1/248; G05D 1/69; G05D 105/15; G05D 107/20; G05D 109/10

(52) U.S. Cl. CPC G05D 1/646; G05D 1/246; G05D 1/248; G05D 1/69; G05D 2105/15; G05D 2107/21; G05D 2109/10

(57) ABSTRACT

A worksite operation system includes one or more processors and memory storing instructions, executable by the one or more processors. The instructions, when executed by the one or more processors, configure the one or more processors to: track position data corresponding to a first set of one or more mobile work machines performing an operation at a worksite; dynamically determine a passability status of each of one or more areas of the worksite based, at least, on the tracked position data corresponding to the first set of one or more mobile work machines; generate a passability database based, at least, on the dynamically determined passability status of each of the one or more areas of the worksite; and generate a respective route for each mobile work machine of a second set of one or more mobile work machines to traverse the worksite based, at least, on the passability database.

### FIELD OF THE DESCRIPTION

The present description relates to operations performed by mobile work machines at worksite, and more specifically to path planning for and navigation of work machines at the worksite.

### BACKGROUND

There are a wide variety of different types of worksite operations performed by a variety of mobile work machines. Some examples include agricultural worksite operations performed by mobile agricultural work machines, construction worksite operations performed by mobile construction work machines, turf management worksite operations performed by mobile turf management work machines, and forestry worksite operations performed by mobile forestry work machines. Path planning, including generation of routes (or paths) for the mobile work machine, and subsequent navigation, including control of the mobile work machines based on the routes (or paths), can be used to provide coordination between the mobile work machines and efficient performance of the worksite operation.

The discussion above is merely provided for general background information and is not intended to be used as an aid in determining the scope of the claimed subject matter.

### SUMMARY

A worksite operation system includes one or more processors and memory storing instructions, executable by the one or more processors. The instructions, when executed by the one or more processors, configure the one or more processors to: track position data corresponding to a first set of one or more mobile work machines performing an operation at a worksite; dynamically determine a passability status of each of one or more areas of the worksite based, at least, on the tracked position data corresponding to the first set of one or more mobile work machines; generate a passability database based, at least, on the dynamically determined passability status of each of the one or more areas of the worksite; and generate a respective route for each mobile work machine of a second set of one or more mobile work machines to traverse the worksite based, at least, on the passability database.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A, 1B, and 1C are pictorial illustrations showing example worksite operations performed by example mobile work machines.

FIG. 2 is a block diagram of one example worksite operation system architecture.

FIG. 3 is a block diagram showing some examples of components of the worksite operation system architecture, including path planning system, in more detail.

FIGS. 4A and 4B are pictorial illustrations showing example path planning operations.

FIG. 5 is a flowchart showing example operation of the worksite operation system architecture in performing dynamic passability status determination, path planning, and control.

FIG. 6 is a block diagram showing one example of items of a worksite operation system architecture in communication with a remote server architecture.

FIGS. 7, 8, and 9 show examples of mobile devices that can be used in a worksite operation system architecture.

FIG. 10 is a block diagram showing one example of a computing environment that can be used in a worksite operation system architecture.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

A plurality of different mobile work machines can operate at a worksite to perform a worksite operation. The plurality of different mobile work machines can include a plurality of different types of mobile work machines. For example, in the context of an agricultural worksite operation, such as a harvesting operation at a worksite (e.g., field), one or more mobile primary work machines (e.g., agricultural harvesters) can operate to harvest crop at the worksite and one or more mobile support work machines (e.g., mobile haulage machines, such as mobile grain carts, mobile grain trailers, etc.) can operate at the worksite to collect and transport the harvested crop. In another example, in the context of an agricultural worksite operation, such as a material application (e.g., planting, spraying, spreading) operation at a worksite (e.g., field), one or more mobile primary work machines (e.g., mobile material application machines, such as planters, sprayers, spreaders) can operate to apply (plant, spray, spread) material (e.g., seed, liquid product, dry product, etc.) at the worksite and one or more mobile support work machine (e.g., mobile supply or tender machines, etc.) can operate at the worksite to supply material to the mobile primary work machines.

To help achieve desired performance of the worksite operation, the plurality of different mobile work machines can be controllably coordinated to traverse the worksite. For instance, routes can be planned for use in control of each mobile work machine so as not to impede (or otherwise interrupt) the operation of other mobile work machines at the worksite, to avoid travel in or intersection with impassable areas, and to arrive at target locations in a timely manner. In the context of path planning and navigation, a worksite can generally be divided into impassable (unavailable for travel by at least some of the mobile work machines) and passable (available for travel by at least some of the work machines) areas. Some impassable and passable areas can be known prior to the operation (e.g. based on maps, overhead imagery, user/operator input, historical operation data at the worksite, third-party sources, etc.). For example, some impassable areas can be known prior to the operation such as static (or substantially static) obstacles (e.g., trees, fences, large rocks, waterways, etc.), areas outside of the boundaries of the worksite, as well as various other impassable areas. In further example, some passable areas can be known prior to the operation, such as roads or trails, tramlines, headlands, as well as various other passable areas. Hower, passable and impassable areas of the worksite can change through the course of the operation. For example, unharvested areas of the worksite are impassable (at least for the mobile support machines) and, once harvested, are passable. In another example, unplanted areas of the worksite are passable and, once planted, are unpassable.

It will of course be understood that passability can be determined (or set) on the basis of preferences rather than, or in addition to, actual physical traversability. Thus, passability of an area of a worksite can be determined based on characteristics corresponding to the area, such as whether the area has already been worked (e.g., harvested, planted, tilled, sprayed, etc.), the presence of obstacles at the area, the location of the boundary relative to the area, as well as various other characteristics such as soil or terrain characteristics, as well as various others. Additionally, as discussed, the passability of an area can be based on preferences of a user or operator rather than, or in addition, to characteristics corresponding to the area.

The systems and methods described herein provide for path planning and navigation that monitors and accounts for change in passability of areas of a worksite at which a worksite operation is being performed. The systems and methods disclosed herein provide monitoring and determining changes in passability of areas of a worksite. The systems and methods provide for monitoring and determining changes in passability during the course of a worksite operation such as by tracking geographic position data (e.g., GNSS data, etc.) of mobile work machines operating at a worksite. The systems and methods provide for updating of a passability database (e.g., passability map of the worksite, etc.) that defines passable and impassable areas at the worksite based on the monitoring and determining of changes in passability. Further, the systems and methods further provide for generation of routes for the mobile work machines and corresponding control of the mobile work machines based on the updated passability database (e.g., updated passable and impassable areas of the worksite).

While various examples described herein proceed in the context of agricultural worksite operations performed by mobile agricultural work machines at agricultural worksite, it will be understood that the systems and methods described herein are applicable to and can be used in a variety of other worksite operations performed by a variety of other mobile work machines at a variety of other worksites. For example, but not by limitation, the stems and methods described herein are applicable to and can be used in construction worksite operations performed by mobile construction work machines at construction worksites, forestry worksite operations performed by mobile forestry work machines at forestry worksites, and turf management worksite operations performed by mobile turf management work machines at turf management worksites.

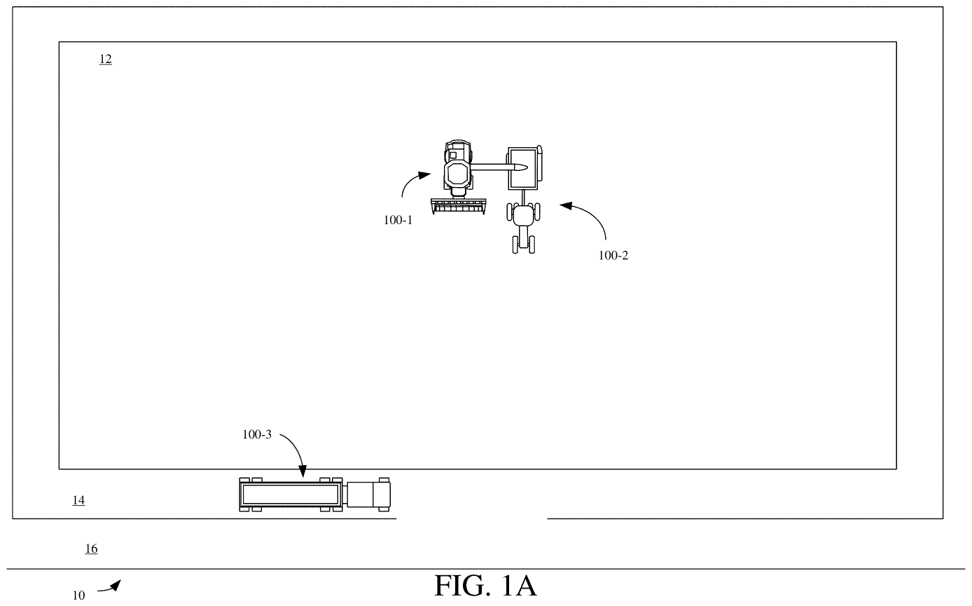

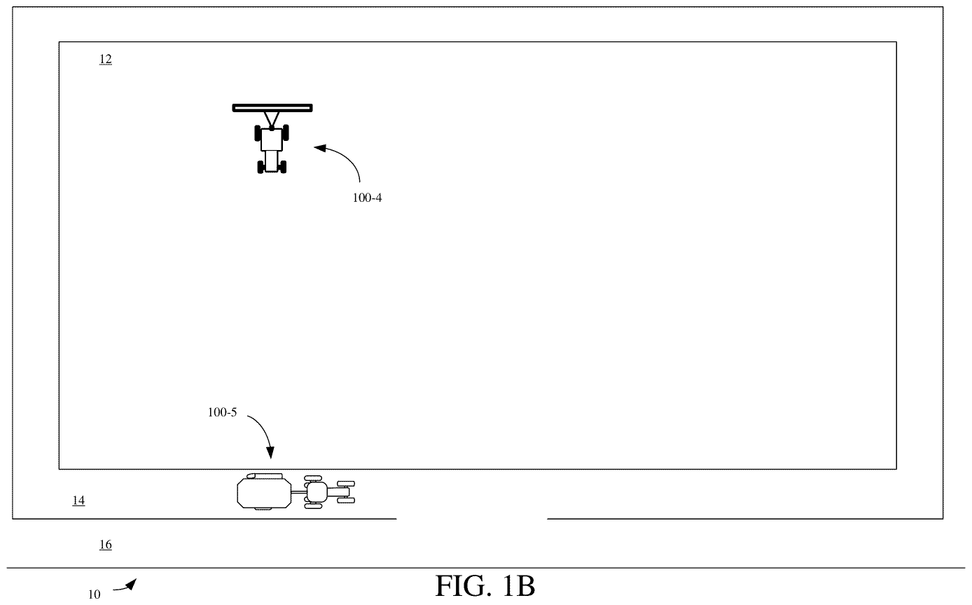

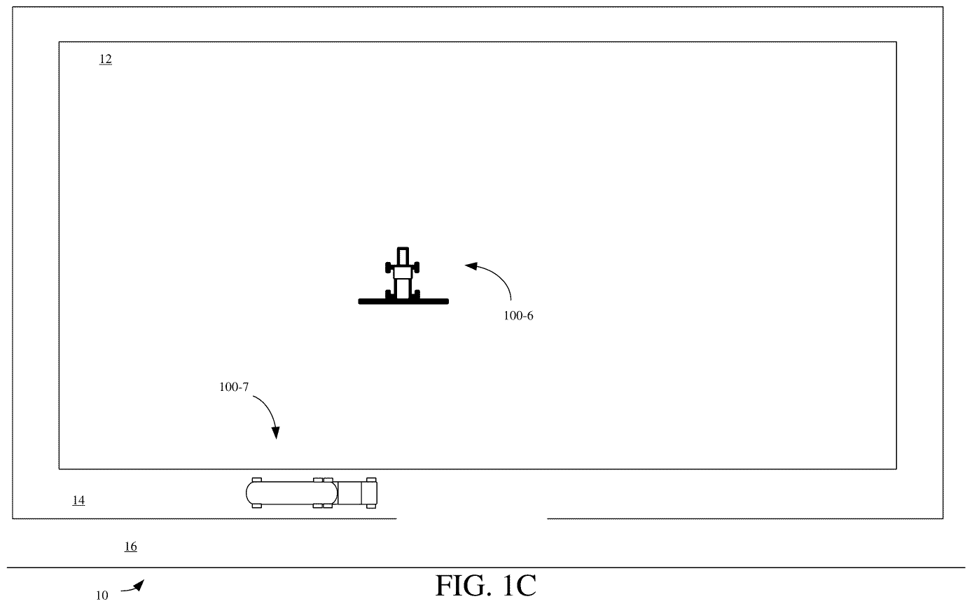

FIGS. 1A, 1B, and 1C are pictorial illustrations showing example worksite operations performed by example mobile work machines 100 at a worksite 10. As illustrated, worksite 10 includes a field 12, headlands 14, and a road 16. While a particular number of mobile work machines are shown in the illustrated examples, it will be understood that, in other examples, more of each type of mobile work machine can be utilized.

The example illustrated in FIG. 1A shows an agricultural worksite operation, illustratively an agricultural harvesting operation. As shown in FIG. 1A, an example mobile primary work machine (illustratively a harvester 100-1) harvests at the field 12, and is supported by example mobile support work machines (illustratively mobile haulage machines 100-2 (mobile grain cart) and 100-3 (mobile grain trailer)). The mobile haulage machines operate to collect and transport crop material harvested by the harvester. It can be seen that the harvester comprises a combine with an attached implement (header). It can be seen that the mobile haulage machines each include a towing vehicle (e.g., tractor or truck) and a towed implement (e.g., grain cart or grain trailer).

The example illustrated in FIG. 1B shows an agricultural worksite operation, illustratively an agricultural material application operation in the form of an agricultural planting operation. As shown in FIG. 1B, an example mobile primary work machine (illustratively a planter 100-4) plants crop seeds at field 12, and is supported by an example mobile support work machine (illustratively a mobile seed supply or tender machine 100-5). The mobile seed tender (or supply) machine operates to supply the planter with crop seeds. It can be seen that the planter comprises a towing vehicle (e.g., tractor) with an attached implement (towed planting implement). It can be seen that the mobile seed tender (or supply) machine includes a towing vehicle (e.g., tractor) and a towed implement (e.g., seed tender (or supply) implement).

The example illustrated in FIG. 1C shows an agricultural worksite operation, illustratively an agricultural material application operation in the form of an agricultural spraying or spreading operation. As shown in FIG. 1C, an example primary mobile work machine (either a sprayer or spreader 100-6) applies (e.g., sprays or spreads) material (e.g., product such as fertilizer, pesticide, herbicide, etc.) at field 12, and is supported by an example mobile support work machine (illustratively a mobile product supply or tender machine 100-7). The mobile product tender (or supply) machine operates to supply the sprayer or spreader with product. It can be seen, in the illustrated example, that the sprayer or spreader is self-propelled. That is the spraying or spreading implement is on the same chassis as the propulsion means (e.g., engine, etc.). However, in other example, a sprayer or spreader can include a towing vehicle (e.g., tractor) with an attached implement (towing spraying or spreading implement). It can be seen that the mobile product tender (or supply) machine includes a towing vehicle (e.g., truck) and a towed implement (e.g., product tender (or supply) implement).

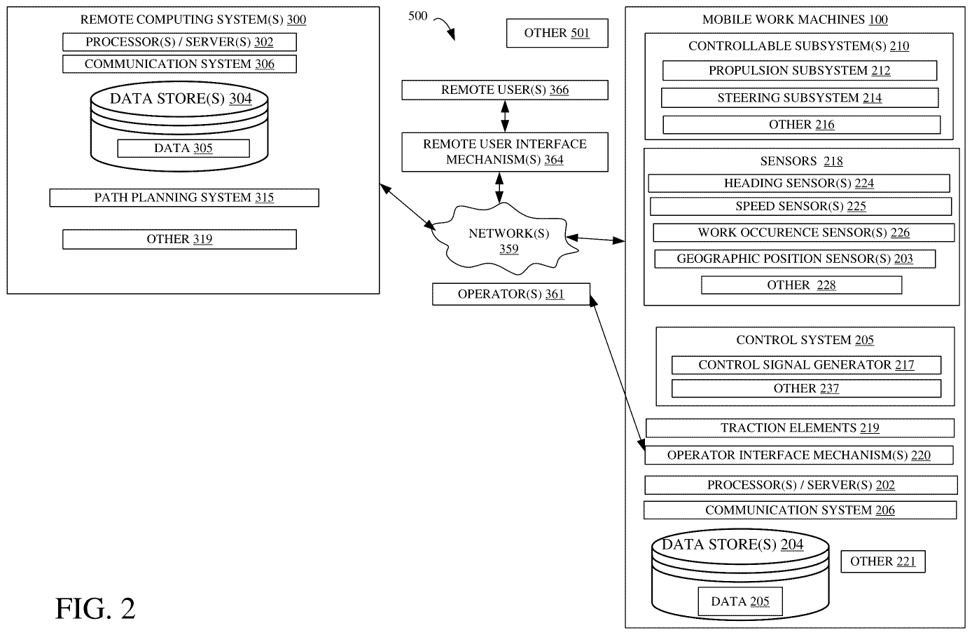

FIG. 2 is a block diagram showing one example worksite operation system architecture 500 (hereinafter also referred to as worksite operation system 500 or as system 500). Worksite operation system 500 includes a plurality of mobile work machines 100. Some examples of mobile work machines 100 are shown in FIGS. 1A, 1B, and 1C (e.g., 100-1, 100-2, 100-3, 100-4, 100-5, 100-6, and 100-7). System 500 also includes one or more remote computing systems 300, one or more networks 359, one or more remote user interface mechanisms 364, and can include a variety of other items 501 as well.

Each mobile work machine 100, itself, illustratively includes one or more processors or servers 202, one or more data stores 204, control system 205, communication system 206, one or more controllable subsystems 210, one or more sensors 218, a plurality of ground engaging traction elements 219, one or more operator interface mechanisms 220, and can include various other items and functionality 221, including, but not limited, to other items and functionality described in FIGS. 1A, 1B, 1C. As previously described, some mobile work machines 100 can be mobile primary work machines (e.g., harvesters, planters, sprayers, spreaders, etc.) and some mobile work machines 100 can be mobile support work machines (e.g., haulage machines, tender or supply machines, etc.).

Remote computing systems 300, as illustrated, include one or more processors or servers 302, one or more data stores 304, communication system 306, path planning system 315, and can include various other items and functionality 319.

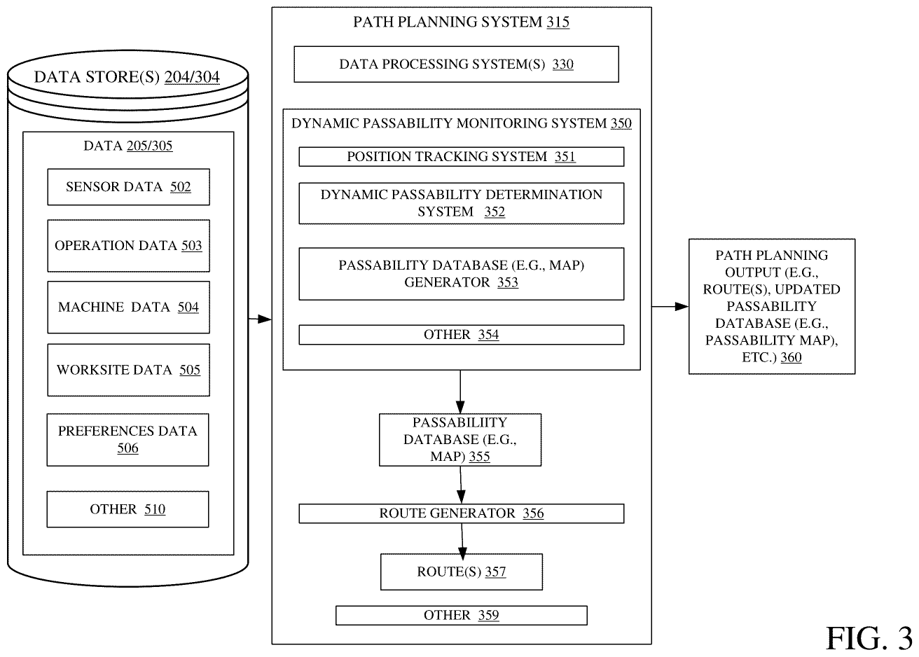

Data stores 204 and data stores 304 each store a variety of data (generally indicated as data 205 and data 305 respectively), some of which will be described in more detail herein. For example, data 205 or data 305, or a combination thereof, can include a variety of data. Some examples of the various data will be described in more detail in FIG. 3. Additionally, data 205 can include computer executable instructions that are executable by one or more processors or servers 202 to implement other items or functionalities of system 500, including other items or functionalities of mobile work machines 100. Additionally, data 305 can include computer executable instructions that are executable by one or more processors or servers 302 to implement other items or functionalities of system 500, including other items of remote computing systems 300. It will be understood that data stores 204 and data stores 304 can include different forms of data stores, for instance both volatile data stores (e.g., Random Access Memory (RAM)) and non-volatile data stores (e.g., Read Only Memory (ROM), hard drives, solid state drives, etc.).

Sensors 218 can include one or more heading sensor systems 224, one or more speed sensors 225, one or more work occurrence sensors 226, one or more geographic position sensors 203, and can include various other sensors 228 as well. The sensor data (e.g., signals, images, etc.) generated by sensors 218 can be communicated to remote computing systems 300, to mobile work machines 100, and to other items of the corresponding mobile work machine 100.

Geographic position sensors 203 illustratively sense or detect the geographic position or location of a corresponding mobile work machine 100. Geographic position sensors 203 can include, but are not limited to, a global navigation satellite system (GNSS) receiver that receives signals from a GNSS satellite transmitter. Geographic position sensors 203 can also include a real-time kinematic (RTK) component that is configured to enhance the precision of position data derived from the GNSS signal. Geographic position sensors 203 can include one or more RADAR sensors, LIDAR sensor, ultrasonic sensors, or cameras that generate sensor data for use in Simultaneous Localization and Mapping (SLAM) to identify the position or location of a mobile work machine 100. Geographic position sensors 203 can include a dead reckoning system, a cellular triangulation system, or any of a variety of other geographic position sensors.

Heading sensors 224 detect a heading characteristic (e.g., travel direction) of a mobile work machine 100. This can include sensors that sense the movement or orientation (e.g., turn angle) of ground-engaging traction elements 219 (e.g., wheels or tracks) or movement of components (e.g., steering shaft, etc.) coupled to the ground engaging traction elements 219 or other elements, or can utilize signals received from other sources, such as geographic position sensors 203. Thus, while heading sensors 224 as described herein are shown as separate from geographic position sensors 203, in some examples, machine heading is derived from signals received from geographic position sensors 203 and subsequent processing. In other examples, heading sensors 224 are separate sensors and do not utilize signals received from other sources.

Speed sensors 225 detect a speed characteristic (e.g., travel speed, acceleration, deceleration, etc.), or both, of a mobile work machine 100. This can include sensors that sense the movement (e.g., rotation) of ground-engaging elements 219 (e.g., wheels or tracks) or movement of components (e.g., axles, etc.), coupled to the ground engaging traction elements 219, or other elements. This can include sensors, such as LIDAR or RADAR. In some examples, signals received from other sources, such as geographic position sensors 203, can be utilized to detect speed characteristics. Thus, while speed sensors 225 as described herein are shown as separate from geographic position sensors 203, in some examples, machine speed is derived from signals received from geographic position sensors 203 and subsequent processing. In other examples, speed sensors 225 are separate sensors and do not utilize signals received from other sources.

Work occurrence sensors 226 detect characteristics indicative of whether work is occurring (e.g., whether a corresponding work machine 100 is performing an operation). For example, work occurrence sensors 226 can include sensors (e.g., hall effect, potentiometers, rotary transducers, accelerometers, electromagnetic radiation transmitter/receiver, etc.) that detect a position of an implement of the corresponding mobile work machine 100. For example, some implements may have a different position when operating then when not operating. For instance, some implements are lowered when in a working state and raised when in a non-working state(e.g., during turns between working passes, during on-road transport, etc.). Additionally, or alternatively, work occurrence sensors 226 can include sensors (e.g., (e.g., hall effect, potentiometers, rotary transducers, accelerometers, electromagnetic radiation transmitter/receiver, etc.) that detect movement or a position of a working component of the mobile work machine 100, such as a working component of an implement of the mobile work machine 100. For instance, some working components change position or move (e.g., rotate, oscillate, etc.) when in a working state. Additionally, or alternatively, work occurrence sensors 226 can include operator or user input sensors (e.g., switches, touch sensors, buttons, digital sensors, software sensors, etc.) that detect a user or operator input into an interface mechanism (e.g., 220, 364, etc.) that indicates work occurring. For instance, a user or operator input may command that a corresponding mobile work machine 100 begin performing work (e.g. activate one or more working components). In another example, an interface mechanism may be configured with an input mechanism (e.g., button, dial, switch, display element, etc.) interactable by the user or operator to indicate whether work is being performed by a corresponding mobile work machine 100.

Sensors 218 can also include various other types of sensors 228.

Control system 205 can be or can include one or more controllers or one or more computing devices, or both, and can further include, or be implemented by, memory (e.g., 204) storing computer executable instructions (e.g., of data 205) and one or more processors 202 that execute the instructions. Control system 205 can include a control signal generator 217.

Control system 205 (e.g., control signal generator 217) can generate control signals to control one or more components of a mobile work machine 100 or components of system 500, or both. For example, but not by limitation, control system 205 can generate control signals to control controllable subsystems 210, communication system 206, as well as operator interface mechanisms 220. In some examples, control system 205 can generate control signals to control items of system 500, such as remote user interface mechanisms 364.

Controllable subsystems 210 can include propulsion subsystem 212, steering subsystem 214, and can include various other controllable subsystems 216 as well.

Propulsion subsystem 212 includes a powerplant (e.g., internal combustion engine, batteries and electric motors, hybrid (combustion engine and batteries and electric motor), etc.) as well as other drivetrain elements (e.g., gearbox, axles, brakes, etc.). Propulsion subsystem 212 is controllable to control a travel velocity (e.g., speed) of a corresponding mobile work machine 100 by controllably driving movement (e.g., rotation) of ground engaging traction elements 219.

Steering subsystem 214 includes one or more controllable actuators (e.g., linear actuators, hydraulic actuators, etc.) and linkages that are controllably actuatable to control the orientation (e.g., turn angle) of ground engaging traction elements 219 and thus, control a heading of a corresponding mobile work machine 100.

Communication system 206 is used to communicate between components of a corresponding mobile work machine 100 or with other items of system 500, such as remote computing systems 300, other mobile work machines 100, user interface mechanisms 364, or a combination thereof. Communication system 306 is used to communicate between components of a corresponding remote computing system 300 or with other items of system 500, such as mobile work machines 100, other remote computing systems 300, user interface mechanisms 364, or a combination thereof.

Communication systems 206 and 306 can each include one or more of wired communication circuitry and wireless communication circuitry, as well as wired and wireless communication components. In some examples, communication systems 206 and 306 can each be a system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 206 and 306 can each also include a system that facilitates downloads or transfers of information to and from a secure digital (SD) card or a universal serial bus (USB) card, or both. Communication systems 206 and 306 can each utilize networks 359. Networks 359 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

FIG. 2 shows that one or more operators 361 can operate mobile work machines 100. The operators 361 interact with operator interface mechanisms 220. In some examples, operator interface mechanisms 220 can each include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of operator input control devices. Where a touch sensitive display system is provided, the operators 361 can interact with operator interface mechanisms 220 using touch gestures. Additionally, at least some of the operator interface mechanisms 220 can be used to present (e.g., display, audible presentation, haptic presentation, etc.) various information. In some examples, some operator interface mechanisms 220 (e.g., mobile devices) may be wirelessly connected to a corresponding mobile work machine 100, such that they can be remote from the corresponding mobile work machine 100 and used by operators 361 to remotely operate the corresponding mobile work machine 100. Operator interface mechanisms 220 can also be utilized by operators 361 to interact, over networks 359, with other items of system 500 such as remote computing systems 300, user interface mechanisms 364, or other mobile work machine 100. The examples described above are provided as illustrative examples and are not intended to limit the scope of the present disclosure. Consequently, other types of operator interface mechanisms 220 can be used and are within the scope of the present disclosure.

FIG. 2 also shows remote users 366 interacting with mobile work machines 100 and remote computing systems 300 through user interface mechanisms 364 over networks 359. In some examples, user interface mechanisms 364 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 366 can interact with user interface mechanisms 364 using touch gestures. Additionally, at least some of the user interface mechanisms 364 can be used to present (e.g., display, audible presentation, haptic presentation, etc.) various information. The examples described above are provided as illustrative examples and are not intended to limit the scope of the present disclosure. Consequently, other types of user interface mechanisms 364 can be used and are within the scope of the present disclosure.

Remote computing systems 300 can be a wide variety of different types of systems, or combinations thereof. For example, remote computing systems 300 can be in a remote server environment. Further, remote computing systems 300 can be remote computing systems, such as mobile devices, a remote network, a manager system, a vendor system, or a wide variety of other remote systems. In one example, mobile work machines 100 can be controlled remotely by remote computing systems 300 or by remote users 366, or both. In some examples, operators 361 are on-board (e.g., in an operator compartment of) the mobile work machines 100. In some examples, operators 361 are remote from the mobile work machines 100 and control the mobile work machines 100 through one or more interface mechanisms 220 which are remote from the mobile work machines 100 but are operatively coupled (e.g., communicatively coupled, such as over networks 359) to the mobile work machines 100.

FIG. 2 also shows that remote computing systems 300 can include path planning system 315. Path planning system 315 is operable to generate routes (or paths) for each of the mobile work machines 100 to travel at a worksite. Additionally, path planning system 215 is operable to monitor, determine, and update passability of areas of the worksite and generate the routes based on the updated passability. Path planning system 315 will be discussed in more detail in FIG. 3.

It will be understood that, in some examples, items in system 500 can be distributed in various ways, including ways that differ from the example shown in FIG. 2. For example, but not by limitation, path planning system 315, shown in FIG. 2 as being disposed on one or more remote computing systems 300, can be disposed elsewhere, such as on one or more mobile work machines 100. In yet other examples, path planning system 315 can be distributed across or disposed on both one or more mobile work machines 100 and one or more remote computing systems 300. These are merely some examples of the distributions contemplated herein.

FIG. 3 is a block diagram that shows examples of some of the components of system 500 in more detail and information flow between the components.

As illustrated in FIG. 3, it can be seen that data stores 204, data stores 304, or a combination thereof, can include as data (205 and 305, respectively), sensor data 502, operation data 503, vehicle data 504, worksite data 505, preferences data 506, and can include various other data 510, including, but not limited to, other data described elsewhere herein. In some examples, where the data is located can depend on where path planning system 315 (also called system 315) is located. The data can be used by path planning system 315 in generating path planning outputs 360, as well as by other items of system 500, such as control system 205.

As shown in FIG. 3, path planning system 315 includes one or more data processing systems 330, dynamic passability monitoring system 350, route generator 356, and can include various other items and functionality 359. Dynamic passability monitoring system 350, itself, includes, position tracking system 351, dynamic passability determination system 352, passability database (e.g., map) generator 353, and can include various other items and functionality 354. As will be described in more detail, system 315 is operable to generate one or more path planning outputs 360.

Sensor data 502 includes sensor data (e.g., images, sensor signals, etc.) generated by sensors 218. Sensor data 502 can include, geographic position sensor data (indicative of geographic positions of mobile work machines 100) generated by geographic position sensors 203, heading sensor data (indicative of headings, turn angles, etc. of mobile work machines 100) generated by heading sensors 224, speed sensor data (indicative of travels speeds of mobile work machines 100) generated by speed sensors 225, work occurrence sensor data (e.g., indicative of work being conducted by mobile work machines 100) generated by work occurrence sensors 226, as well as various other sensor data generated by other sensors 228.

Operation data 503 includes data indicative of one or more parameters of the operation being performed by the one or more mobile work machines 100. For example, operation data 503 can include data that indicates type of operation being performed at the worksite (e.g., harvesting, material application (e.g., spraying, spreading, planting, etc.), etc.). Operation data 503 can include operation design data such as prescriptive operating settings for one or more mobile work machines 100, planned routes of one or more mobile work machines 100, as well as various other operation design data. Operation design data can include designated locations or areas of the worksite at which a support mobile work machine 100 is to be positioned to perform a support operation (e.g., material transfer operation) such as, for instance, a headland (e.g., headland closest to current location of corresponding primary mobile work machine 100). Operation data 503 can include fill strategy data that indicates the fill strategy to be used to transfer material from one mobile work machine 100 to another mobile work machine 100. The fill strategy data can indicate the order as to how a work machine 100 is to be filled (e.g., front-to-back, back-to-front, etc.), the location(s) at which the material transfer operation is to take place (e.g. in a headland, side-by-side in tandem, etc.), as well as various other fill strategy data. Operation data 503 can include thresholds, such as threshold values or threshold value ranges for various operating settings, such as minimum and/or maximum travel speeds, as well as various other operating settings. Operation data 503 can include a variety of other data. Operation data 503 can be derived from one or more of a variety of sources including, but not limited to, dealer or manufacturer provided information, operator or user input, as well as a variety of other sources.

Machine data 504 includes data indicative of one or more characteristics of each of the one or more mobile work machines 100 that are to perform, are to perform, or are available to perform the operation at the worksite. Machine data 504 can include dimensional data such as machine dimensions, such as length, width, and height of the machine 100 or of components of the machines 100, as well as positions of components of the machines 100 as well as distances between components of the machines 100. Dimensional data can include machine swath width (e.g., the working width of an implement or work component of the machines 100). Machine data 504 can include various other dimensional data. Machine data 504 can include machine ratings (machine capabilities), such as travel speed ratings (e.g., minimum and maximum travel speeds), machine turn radius, as well as various other machine ratings. Machine data 504 can be derived from one or more of a variety of sources including, but not limited to, dealer or manufacturer provided information, operator or user input, as well as a variety of other sources.

Worksite data 505 includes data indicative of attributes of worksite(s) at which operation(s) are to be performed by mobile work machines 100. Worksite data 504 can include maps or other georeferenced data of the worksites. Worksite data 504 can include location and boundary information for the worksite, location and boundary information for items and areas of the worksite, such as location and boundary information for passable and impassable areas, as well as location and boundary information for various other items and areas of the worksite. Worksite data 505 can include identifying (e.g., typing) information for items and areas of the worksite. For example, whether an area is a crop area, a headland, a road, a trail, a tramline, an obstacle (type of obstacle such as a tree, fence, large rocks, waterways, ditches, etc.). In one example, worksite data 505 can include a passability database (e.g. map) that indicates locations and boundaries, as well as identifying (e.g., typing) information, for passable and impassable areas of a worksite known prior to a particular operation at the worksite. Such a passability database (e.g., map) can be referred to as an a priori passability database (e.g., map). As will be discussed later, dynamic passability monitoring system 350 can update an a priori passability database (e.g., map) to dynamically update passable and impassable areas at the worksite throughout the course of an operation. Worksite data 504 can also include maps or other georeferenced data indicative of various other characteristics of the worksite, such as topographic characteristics (e.g., elevation, slope, surface roughness, etc.), soil characteristics (e.g., soil type, soil moisture, etc.), as well as various other characteristics. Worksite data 505 can be obtained from one or more of a variety of sources including operator or user input, overhead (e.g., aerial, satellite, etc.) imagery, historical operation data (e.g., sensor data from prior operations at the worksite), third-party providers, as well as a variety of other sources.

Preferences data 506 includes data indicative of preferences useable by path planning system in generating path planning outputs 360. For example, preferences data can include preferences for route generation, such as preferences to maximize travel on certain areas of a worksite such as roads, trails, or headlands and to minimize travel in other areas such as crop areas, even when deemed passable. For instance, an operator or user may prefer to maximize travel on certain areas such as roads, trails, or headlands, and minimize travel on other areas such as crop areas, to avoid or reduce compaction on the other areas (e.g., crop areas) even when those other areas are passable. Preferences data 506 can include other preferences for route generation such as preferences to generate the quickest route or the shortest route (which may or may not be the quickest route). Preferences data 506 can include other preferences for route generation such as preferences to follow the direction of the crop rows (this way ground engaging traction elements of the mobile work machine 100 can travel between rows of crops and avoid traveling over the rows of crop). Preferences data 506 can include other preferences for route generation such as preferences to generate routes with the smoothest ride or otherwise based further on topographic data. For instance, it may be especially desirable to reduce machine bouncing (e.g., from changes in topography) for operator ride comfort or to reduce the likelihood of material spillage. It will be understood that multiple preferences can be utilized in the same route generation. For example, but not by limitation, a preference to maximize travel in certain areas (e.g., headlands) and to follow crop row direction when traveling in crop areas can both be utilized in route generation. Preferences data 506 can include cost preferences that can be utilized to categorize passable areas into cost categories (e.g., high cost, low cost, etc.). For instance, an area may be passable but may be deemed as high cost given cost preferences indicated in preferences data. These are merely some examples. Preferences data 506 can be obtained from operator or user input. In some examples, preferences data 506 can be obtained from a variety of other sources.

Data processing systems process sensor data 502, operation data 503, machine data 504, worksite data 505, preferences data 506, and other data 510 to generate processed data. The processed data can include computer readable values, useable (or readable) by other items of path planning system 215 or by other items of system 500. Data processing systems 330 can include various processing functionality, including image processing functionality, sensor signal processing functionality, filtering functionality, categorization functionality, normalization functionality, aggregation functionality, color extraction functionality, analog-to-digital conversion functionality, other conversion functionality (e.g., look up tables, equations, mathematical functions, models, etc.), as well as various other data processing functionalities. It will be understood then that data processing systems 330 can, for example, convert analog signals to readable digital signals (or digital values). It will be understood that data processing systems 330 can, for example, process captured images to extract values (e.g., pixel values, etc.), and can further convert the extracted values. It will be understood that data processing systems 330 can perform pre-processing and post-processing. It will be understood that data processing systems 330 can perform various forms of aggregation on the extracted or converted values. These are merely some examples of processing functionalities of data processing systems 330.

Dynamic passability monitoring system 350 is operable to, during the course of an operation at a worksite, monitor and determine changes in passability at the worksite and, based thereon, continuously or periodically update a passability database 355 that indicates, among other things, the locations and boundaries of passable and impassable areas of a worksite. Dynamic passability monitoring system 350 is operable to monitor and determine changes in passability and to update the passability database 355 based, at least, on data 205/305. The updated passability database 355 (e.g., updated passability map) is useable by route generator 356, along one or more items of data 205/305, to generate routes 357 for one or more mobile work machines 100. Thus, it can be seen that path planning system 315 is operable to, based, at least, on data 205/305, generate one or more path planning outputs 360 which can include one or more routes 357, an updated passability database 355, as well as other information.

Position tracking system 351 is operable to track and aggregate position information provided in sensor data 502 (e.g., position sensor data generated by position sensors 203) for each of the one or more mobile work machines 100 during the course of an operation at a worksite. The tracked and aggregated position information (herein also referred to as tracked position data) can indicate the areas of the worksite covered (e.g., worked) by the one or more mobile work machines 100 at the worksite. The tracked and aggregated position data may be further processed by position tracking system 351 to extrapolate the coverage (worked area), based, at least, on machine data 504 (e.g., dimensions of the mobile work machine 100 and location of the geographic position sensor 203 on the work machine 100). For example, position tracking system 351 may extrapolate the coverage by generating cells, tiles, grids, polygons (or other shapes) representing a coverage (e.g., working width and length) of the mobile work machine 100 for the corresponding sample of the position sensor 203 based on machine data 504. These cells, tiles, grids, polygons (or other shapes) can be further aggregated into quadkeys and quadtrees or can be otherwise merged to generate bigger cells, tiles, grids polygons (or other shapes). Such aggregation can include polygon simplification or vectorization.

Optionally, position tracking system 351 may filter out position data recorded when the mobile work machine 100 is not performing work (referred to as non-working position data), such as during turns in headlands (or other turns) or when the implements are not operating. Position tracking system 351 can filter out the non-working position data based, as least, on sensor data 502 such as heading sensor data generated by heading sensors 224 indicating when the mobile work machine 100 is making a non-working turn (e.g., detected turn angle over a given threshold) and work occurrence sensor data generated work occurrence sensors 226 (indicating the implement(s) of the mobile work machine 100 are not in a working position (e.g., raised or raised above a threshold) or are not in working operation (e.g., one or more working components of the implement are not activated). In some examples, position tracking system 351 does not filter out non-working position data, instead, such filtering is performed by dynamic passability determination system 352, as will be discussed below.

Dynamic passability determination system 352 is operable to dynamically, throughout the course of an operation at a worksite, determine whether areas of the worksite are passable or impassable based, at least, on the tracked position data provided by position tracking system 351 and data 205/305. For example, dynamic passability determination system 352 can change the passability status of areas of the worksite when such areas are covered (e.g., areas worked by mobile work machines during the course of the operation). The passability status of a covered area depends on the type of operation (e.g., indicated by operation data 504) or type of mobile work machines 100 (e.g., indicated by machine data 504). For example, during a planting operation with a planter (e.g., 100-4), an area may initially be determined (e.g., by dynamic passability determination system 352 based on worksite data 505) as passable, prior to being worked (planted) by the planter and may be dynamically determined by dynamic passability determination system 352 as impassable once worked (e.g., planted) by the planter. In another example, during a harvesting operation with a harvester (e.g., 100-1), an area may initially be determined (e.g., by dynamic passability determination system 352 based on worksite data 505) as impassable, prior to being worked (harvested) by the harvester and may be dynamically determined by dynamic passability determination system 352 as passable once worked (e.g., planted) by the planter.

Dynamic passability determination system 352 can also determine passability status of areas of the worksite based on data 205/305, such as worksite data 504. For example, some impassable and passable areas of the worksite may be known prior to the operation (or can be determined based on characteristics identified prior to the operation) and can be indicated in worksite data 504 which can be obtained by dynamic passability determination system 352.

Additionally, dynamic passability determination system 352 may add or otherwise utilize a buffer when designating passable and impassable areas. A buffer may be utilized to account for position tracking error, operator error (error in guiding mobile work machine 100), or as a general precautionary measure. For example, a buffer of half the width of a mobile work machine 100 (or half the working width of the mobile work machine 100) for which a route is to provided may be used as a buffer. In another example, another value for the buffer can be used (e.g., five feet, 20 inches, etc.). In one example, the buffer increases the boundary of an impassable area or decreases the boundary of an impassable area. In another example, the buffer can be a separately designated zone (e.g., a buffer zone) proceeding from the boundaries of a passable or impassable area. Thus, the buffers (or buffer zones) can be, in some examples, added to the passability database (e.g., passability map) such as with corresponding display elements showing the buffer (or buffer zones) or by adjusting the size of the display elements for the passable and impassable areas to account for the buffer (or buffer zones). In some examples, a buffer is instead used by route generator 356 to keep routes at a buffer distance from the boundaries of the passable or impassable areas, as will be discussed below.

Further, in some examples, dynamic passability determination system 352 may filter out position data, provided by position tracking system 351, recorded when the mobile work machine 100 is not performing work (non-working position data), such as during turns in headlands (or other turns) or when the implements (or portions of the implements) are not operating. Dynamic passability determination system 352 can filter out the non-working position data based, as least, on sensor data 502 such as heading sensor data generated by heading sensors 224 indicating when the mobile work machine 100 is making a non-working turn (e.g., detected turn angle over a given threshold) and work occurrence sensor data generated work occurrence sensors 226 (indicating the implements are not in a working position (e.g., raised or raised above a threshold) or are not in working operation (e.g., one or more work components are not activated). In some examples, a portion of travel of a mobile work machine 100 may be working and another portion may be non-working. For example, only a portion of an implement may be operating (e.g., a certain number of planter row units, harvest header row units, nozzles, tillage tools, etc.) may be operating such that the position data corresponding travel path of the operating portion of the implement is considering working position data, whereas the position data corresponding to the travel path of the non-operating portion of the implement is considered non-working position data. Dynamic passability determination system 352 can filter the position data corresponding to the operating portion of the implement and can utilize machine data 504 (e.g., indicating the locations and distances between the components of the implement) to filter the position data such that it indicates the travel path of the working portion of the implement. Thus, a pass (or path) of the machine may be partially working and partially non-working and can be identified by dynamic passability system 350. As discussed above, in some examples, such filtering is instead performed by position tracking system 351.

However, the non-working travel of the mobile work machines 100 are filtered, dynamic passability determination system 352 is able to reclassify areas as passable or impassable based on working travel of the mobile work machines 100. In this way, travel of the mobile work machines 100, during which work is not performed (e.g., headland turns, when the implements (or portions thereof) are off or raised, etc.), does not cause misclassification of the passability status of an area at which the non-working travel occurred.

Passability database (e.g., passability map) generator 353 is operable to generate a passability database (e.g., passability map) 355 based on the passability status determinations by dynamic passability determination system 352 and data 205/305. In some examples, as previously discussed, worksite data 505 may include an a priori passability database (e.g., a priori passability map) that is updated by passability database (e.g., passability map) generator 353 to generate an updated passability database (e.g., passability map) 355. In other examples, passability database (e.g., passability map) generator 353 may not update an a priori passability database, but rather generates an initial passability database (e.g., passability map) 355 that is iteratively updated throughout the operation. In such examples, passability database generator 353 may utilize a worksite map that shows items and areas of the worksite (without a prior passability designations), and those items and areas are designated with a passability status by dynamic passability determination system 352.

The passability database (e.g., passability map) 355 shows the areas and items of the worksite along with their passability statuses. The passability database (e.g., passability map) 355 is useable by route generator 356, along with data 205/305, to generate routes 357 for mobile work machines 100 at the worksite. For example, based on the passability database 355 and data 205/305 route generator 356 is operable to generate routes for support mobile work machines 100 to meet or rendezvous with primary mobile work machines.

Route generator 356 is operable to identify a starting point or position (e.g. current location of a mobile work machine 100 for which a route is to be generate, as indicated by sensor data 502 (e.g., position sensor data generated by position sensors 203)) and a target point or position to which the mobile work machine 100 is to travel. The target point or position may be a current position of a primary mobile work machine 100 (e.g., as indicated by sensor data 502, such as position sensor data generated by position sensors 203) or a future position of a primary mobile work machine 100 (e.g., as indicated by a planned route of operation data 503 or as estimated based on current position, heading, and speed information of sensor data 502 (e.g., position sensor data generated by position sensors 203, heading sensor data generated by heading sensors 224, and speed sensor data generated by speed sensors 225). In some examples, a target point or position may be identified based on operation data 503, such as design data or fill strategy data indicating how and where a support mobile work machine 100 is to be positioned to provide material to or receive material from a corresponding primary mobile work machine 100. In other examples, a target point or position may be identified based on operator or user input designating the target point or position. A target point or position may be identified in various other ways.

Route generator 356 is further operable to generate a route 357 from a starting point or position to a corresponding target point or position based, at least, on the passability database (e.g., passability map) 355 and data 205/305. For example, route generator 356 may generate a route 357 from a starting point or position to a target point or position based on the impassable and passable areas indicated by the passability database 355 and based further on one or more items of data 205/305. For example, based further on preferences data 506. For instance, route generator 356 can generate a route to traverse the passable areas (indicated by passability database 355) from the start point or position to the target point or position according to the preferences of preferences data 506 (e.g., the shortest route, the quickest route, maximizing travel on certain types of areas (e.g., headlands), minimizing travel on crop areas, following crop rows, route with smoothest ride, cost categorization (e.g., high cost, low cost), etc.). Additionally, or alternatively, based further on machine data 504 corresponding to the mobile work machine 100 for which the route is being generated. For instance, route generator 356 can generate a route 357 to traverse the passable areas (indicated by passability database 355) from the start point or position to the target point or position according to machine data 504 (e.g., a route that complies with machine ratings (e.g., turn radius), a route that provides timely arrival according to machine ratings (e.g., machine travel speed), a route that avoids intersection with or travel in impassable areas according to machine dimensions, etc.).

Thus, it can be seen that route generator 356 is operable to generate routes 357 for one or more mobile work machines 100 at the worksite based on passability database 355 and data 205/3058.

It can be seen that path planning system 315 is operable to generate one or more path planning outputs 360 useable to automatically control mobile work machines 100 to operate at a worksite. A path planning output 360 can include one or more routes 357 for each of one or more mobile work machines 100 to traverse a worksite. A path planning output 360 can also include an updated passability database (e.g., updated passability map) 355. Control system 205 can automatically generate control signals to control controllable subsystems 210 based on a path planning output 360 in order to automatically control a mobile work machine 100. Control system 205 can automatically generate control signals to control interface mechanisms (e.g., 220 or 364, or both) based on a path planning 360, such as to present (e.g., display, etc.) the path planning output 360 or information (e.g., routes 357, updated passability database 355, or both) derived therefrom.

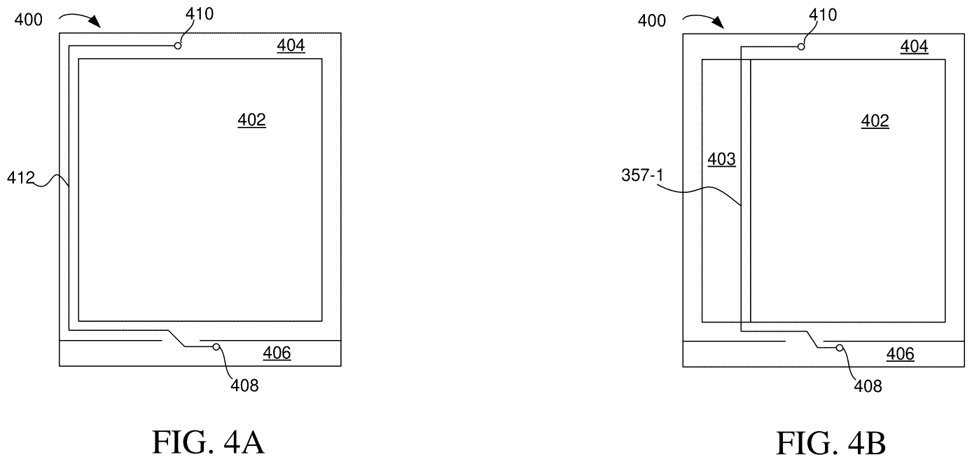

FIGS. 4A and 4B are pictorial illustrations showing example path planning operations at a worksite. FIG. 4A shows an example of path planning at a worksite 400 with a system that does not include path planning system 315. FIG. 4B shows an example of path planning at the worksite 400 with a system that includes path planning system 315.

As shown in FIG. 4A, the worksite includes a crop area 402, a headland 404, and a road 406. A harvester (not shown) is currently harvesting crop at the crop area 402 and a route is to be generated for a mobile grain cart to rendezvous with the harvester at target point 410. The system in FIG. 4A does not dynamically determine passability during the course of the operation and thus, generates route 412 to take the grain cart from the start point 408 to the target point 410. As can be seen, the route 412 traverses areas of the worksite (road 406 and headland 404) that are known (or deemed), a priori (prior to the operation), to be passable. The system in FIG. 4A fails to account for the coverage of the mobile work machine 100 (e.g., harvester) during the operation and to identify, during the course of the operation, changes in passability state at the worksite.

System 500 operates in the example shown in FIG. 4B. Path planning system 315 monitors and tracks position data of the harvester and dynamically, during the course of the operation, deems a portion 403 of the crop area 402 as passable, and outputs a passability database 355 indicated this dynamically updated passability of the worksite 400. Based, at least, thereon, path planning system 315 generates a route 357 (illustratively 357-1) that traverses passable portion 403 of crop area 402. Route 357-1 is shorter than route 412, thus saving time and/or fuel and, as shown, follows the direction of the crop rows at crop area 402.

As can be seen in FIG. 4B, system 500 accounts for the coverage of the mobile work machine 100 (e.g., harvester) during the operation and identifies, during the course of the operation, changes in passability state at the worksite.

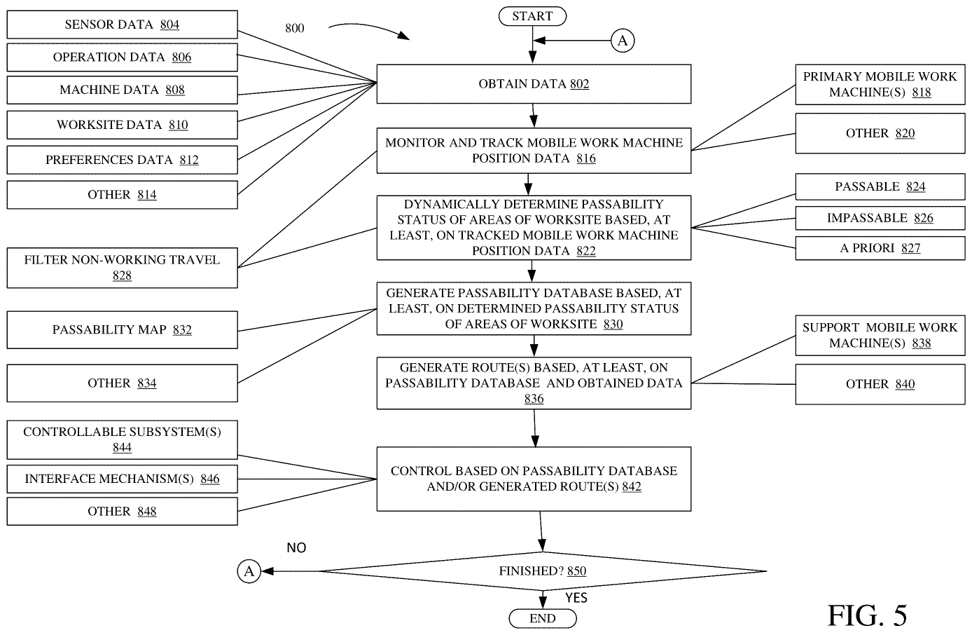

FIG. 5 is a flowchart showing one example method 800 of system 500 in performing dynamic passability status determination, path planning, and control. In the example shown in FIG. 5, it is assumed that a worksite operation at a worksite has begun. Though, in other examples, the method 800 can begin prior to commencement of a worksite operation at a worksite.

At block 802, system 500 (e.g., path planning system 315) obtains one or more items of data 205/305 for path planning. The one or more items of data can include sensor data 502, as indicated by block 804. The one or more items of data can include operation data 503, as indicated by block 806. The one or more items of data can include machine data 504, as indicated by block 808. The one or more items of data can include worksite data 505, as indicated by block 810. The one or more items of data can include preferences data 506, as indicated by block 812. The one or more items of data can include various other data (e.g., 510, etc.), as indicated by block 814.

At block 816, path planning system 315 (e.g., position tracking system 351) monitors and tracks position data for one or more mobile work machines 100 operating at the worksite. Path planning system 315 utilizes sensor data 502, such as position sensor data generated by position sensor 203, generated during the course of the operation. As indicated by block 818, path planning system 315 can monitor and track position data for one or more primary mobile work machines (e.g., harvesters, planters, sprayers, spreaders, etc.). Alternatively, or additionally, path planning system 315 can monitor and track position data for other types of mobile work machines 100 (e.g., support mobile work machines), as indicated by block 820. Examples of the operation of path planning system 315 (e.g., position tracking system 351) in monitoring and tracking position data for one or more mobile work machines are described in FIG. 3. As previously discussed, the monitored and tracked position data can be aggregated in various ways.

At block 822, path planning system 315 (e.g., dynamic passability determination system 352) dynamically determines passability status of areas of the worksite based, at least, on the tracked position data for the one or more mobile work machines 100. Path planning system 315 is operable to determine whether areas are passable or impassable, as indicated by block 824 and 826, respectively, based, at least on the tracked position data for the one or more mobile work machines 100. Additionally, as previously described, and as indicated by block 827, the passability status of some areas of the worksite may be known a priori or may be determinable based on data collected a priori. The a priori passability status or a priori data may be provided in worksite data 505. Thus, path planning system 315 can also determine the passability status of some areas of the worksite based on the a priori passability status or the a priori data. Further, as previously discussed, path planning system 315 may, in determining passability status, change (redesignate) an area of the worksite from a first passability status to a second passability status, such as to change from passable to impassable or from impassable to passable. Further, the passability status determination may depend on the type of operation being performed (e.g., as indicated by operation data 503) or based on the type of mobile work machine(s) 100 to which the position tracking data corresponds (e.g., as indicated by machine data 504). Examples of the operation of path planning system 315 (e.g., dynamic passability determination system 352) in dynamically determining passability status of areas of the worksite are described in FIG. 3.

As previously discussed, and as indicated by block 828, non-working position data (or non-working travel) of the mobile work machines 100 can be filtered. The filtering may be performed by position tracking system 351 or by dynamic passability determination system 352. In this way, non-working travel of the mobile work machines 100 does not cause erroneous passability status determinations for areas at which the non-working travel occurred. In one example, as previously discussed, path planning system 315 is operable to determine whether position data (or travel) of the mobile work machines 100 is non-working based on sensor data 502 such as heading sensor data generated by heading sensors 224 or work occurrence sensor data generated by work occurrence sensor 226. As previously discussed, a pass (or path) of a mobile work machine 100 can be partially working and non-working, and this can be identified. Examples of the operation of path planning system 315 in identifying and filtering non-working position data (or non-working travel) of the mobile work machines 100 are described in FIG. 3.

At block 830, path planning system 315 (e.g., passability database generator 353) generates a passability database 355 based, at least, on the determined passability status of areas of the worksite. A passability database 355 includes the locations and boundaries of passable and impassable areas at the worksite. In some examples, as indicated by block 832, the passability database 355 may be in the form of a passability map of the worksite. In other examples, a passability database 355 may be in forms other than a map. The passability database (e.g., passability map) can include various other items of information as well, including boundaries of the worksite, positions of mobile work machines 100 at the worksite, items or obstacles at the worksite (e.g., rocks, waterways, fences, trees, etc.), typing information for areas of the worksite (e.g., roads, trails, crop areas, headlands, ditches, etc.), buffers (or buffer zones), as well as various other information. As previously described, the passability database 355 may be an updated passability database, that is, a previous passability database (e.g., of worksite data 505) may be updated with the dynamically determined passability statuses of the areas of the worksite (and can be iteratively updated throughout the operation). In other examples, as previously described, the passability database 355 may be newly generated (and can be iteratively updated throughout the course of the operation). Examples of the operation of path planning system 315 (e.g., passability database generator 353) in generating a passability database 355 are described in FIG. 3.

At block 836, path planning system 315 (e.g., route generator 356) generates one or more routes 357 for each of one or more mobile work machines 100 to traverse the worksite based, at least, on the passability database 355. As previously, discussed, path planning system 315 can additionally utilize one or more items of data 205/305 in generating routes 357. As indicated by block 838, path planning system 315 can generate routes 357 for one or more support mobile work machines (e.g., mobile grain carts, mobile grain trails, mobile tender machines, etc.) in order to support and rendezvous with one or more primary mobile work machines. Alternatively, or additionally, path planning system 315 can generate routes 357 for other types of mobile work machines 100 (e.g., primary mobile work machines), as indicated by block 840. As previously discussed, path planning system 315 (e.g., route generator 356) is operable to identify a starting point or position and a target point or position and generate a route to cause travel from the starting point or position to the target point or position. It will be noted that path planning system 315 (e.g., route generator 356) can generate routes 357 for the mobile work machine(s) 100 (e.g., primary mobile work machines) from which the position tracking data is derived to determine passability at the worksite, such as to generate routes 357 for the mobile work machines 100 to avoid overlap or redundant travel (e.g., again operating in an already worked area). Examples of the operation of path planning system 315 (e.g., route generator 356) in identifying starting and target points or positions are described in FIG. 3. Further, as previously discussed, path planning system 315 (e.g., route generator 315) can generate routes 357 based further on preferences of preferences data 506, machine dimension and ratings data of machine data 504, as well as based on various other data of data 205/305. Further, as previously discussed, path planning system 315 (e.g., route generator 315) can generate routes based further on a buffer. Examples of the operation of path planning system 315 (e.g., route generator 356) in generating routes 357 are described in FIG. 3.

At block 842, one or more control systems 205 obtain the passability database 355 and the route(s) 357 (e.g., as a path planning output 360) and institute automatic control based on the passability database 355 or the routes 357, or both.

As indicated by block 844, each control system 205 can automatically control one or more controllable subsystems 210 of a corresponding mobile work machine 100. For instance, each control system 205 can automatically control the propulsion subsystem 210 and steering subsystem 214 of a corresponding mobile work machine 100 to travel a corresponding route 357. Additionally, or alternatively, each control system 205 can automatically control one or more interface mechanisms (e.g., 220 or 364, or both) to present (e.g., display, etc.) the path planning output or information (e.g., routes 357 or passability database (e.g., map) 355, or both) derived therefrom, as indicated by block 846. Additionally, or alternatively, each control system 205 can automatically control one or more other items of system 500, as indicated by block 848.

At block 850 it is determined if the operation at the worksite is complete. If the operation at the worksite is not complete, then processing returns to block 802. If, at block 850, the path planning operation is complete, then processing ends.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, generators, and interactions. It will be appreciated that any or all of such systems, generators, and interactions can be implemented by hardware items, such as one or more processors, one or more processors executing computer executable instructions stored in memory, memory, or other processing components, some of which are described below, that perform the functions associated with those systems, logic, generators, or interactions. In addition, any or all of the systems, generators, and interactions can be implemented by software that is loaded into a memory and is subsequently executed by one or more processors or one or more servers or other computing component(s), as described below. Any or all of the systems, generators, and interactions can also be implemented by different combinations of hardware, software, firmware, etc., some examples of which are described below. These are some examples of different structures that can be used to implement any or all of the systems, generators, and interactions described above. Other structures can be used as well.

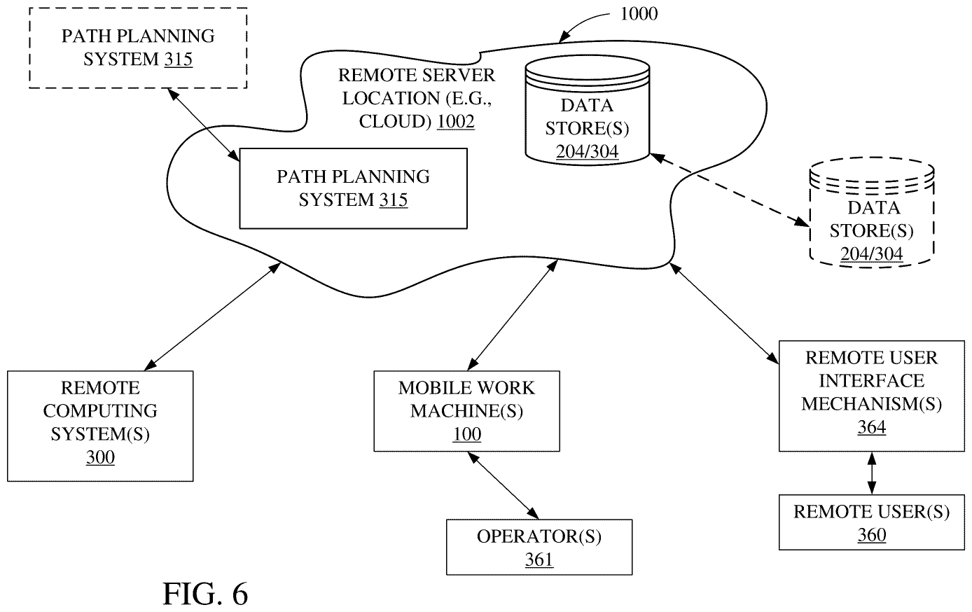

FIG. 6 is a block diagram of a remote server architecture 1000. FIG. 6, also shows one or more mobile work machines 100, one or more remote computing systems 300, and one or more remote user interface mechanisms 364 in communication with the remote server environment. The mobile work machines 100, remote computing systems 300, and remote user interface mechanisms 364 communicate with elements in a remote server architecture 1000. In some examples, remote server architecture 1000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 6, some items are similar to those shown in previous figures and those items are similarly numbered. FIG. 6 specifically shows that path planning system 315, data stores 204 or data stores 304, or a combination thereof, can be located at a server location 1002 that is remote from the mobile work machines 100, remote computing systems 300, and remote user interface mechanisms 364. Therefore, in the example shown in FIG. 6, mobile work machines 100, remote computing systems 300, and remote user interface mechanisms 364 access systems through remote server location 1002. In other examples, various other items can also be located at server location 1002, such as various other items of worksite operation system architecture 500.

FIG. 6 also depicts another example of a remote server architecture. FIG. 6 shows that some elements of previous figures can be disposed at a remote server location 1002 while others can be located elsewhere. By way of example, one or more of data store(s) 204 and 304 can be disposed at a location separate from location 1002 and accessed via the remote server at location 1002. Similarly, path planning system 315 can be disposed at a location separate from location 1002 and accessed via the remote server at location 1002. Regardless of where the elements are located, the elements can be accessed directly by mobile work machines 100, remote computing systems 300, and remote user interface mechanisms 364 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., mobile work machine 100) comes close to the machine containing the information collection system, such as a fuel truck prior to fueling, or other mobile machine or vehicle, the information collection system collects the information from the mobile machine (e.g., mobile work machine 100) using any type of ad-hoc wireless connection. The collected information can then be forwarded to another network when the machine containing the received information reaches a location where wireless telecommunication service coverage or other wireless coverage is available. For instance, a fuel truck can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., mobile work machine 100) until the mobile machine enters an area having wireless communication coverage. The mobile machine (e.g., mobile work machine 100), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

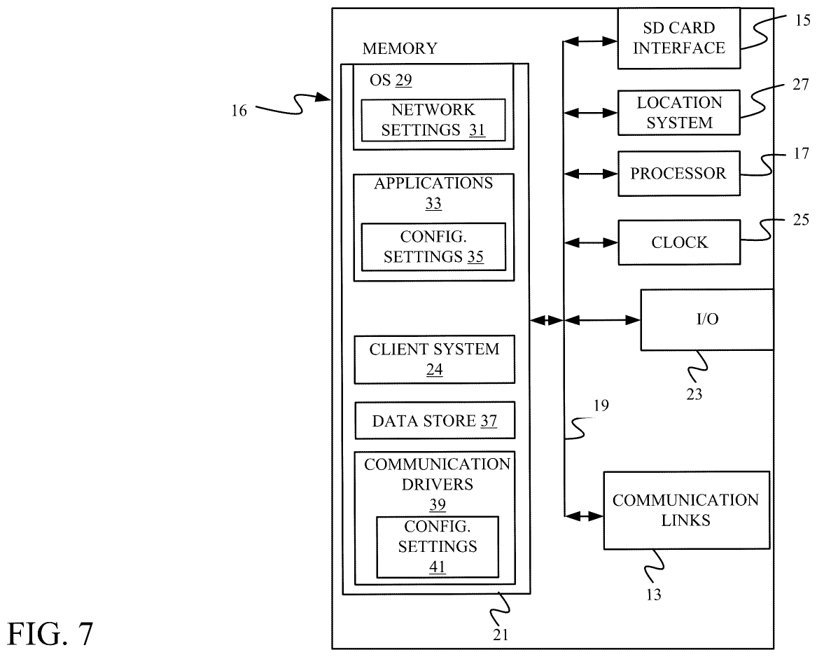

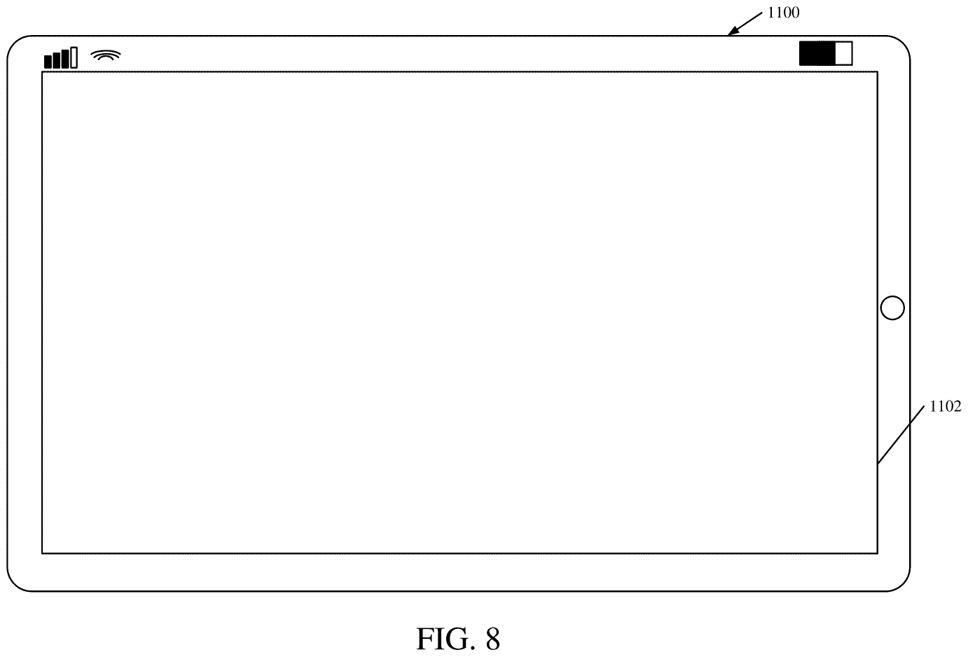

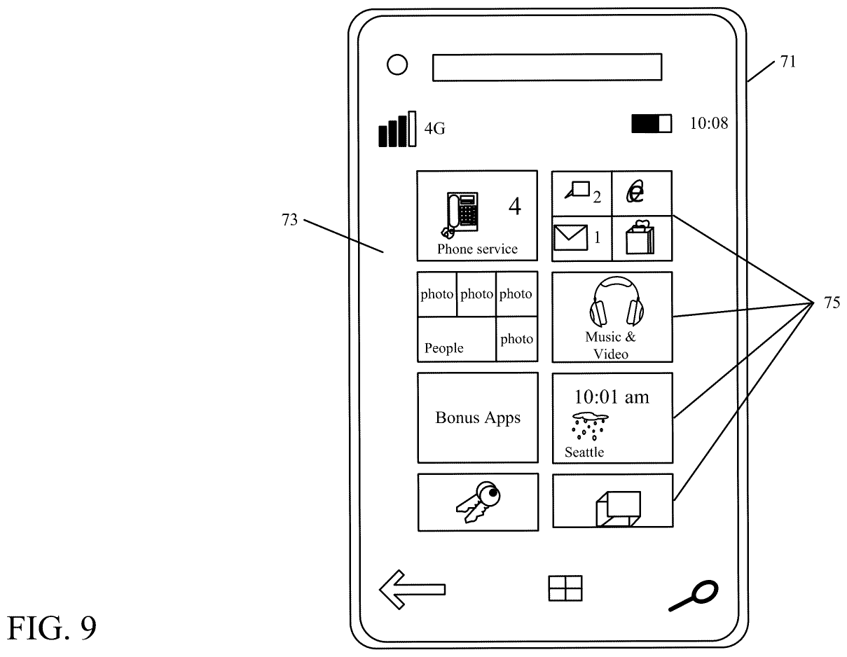

FIG. 7 is a simplified block diagram of one illustrative example of a handheld or mobile computing device that can be used as a user's or client's handheld device 16, in which the present system (or parts of it) can be deployed. For instance, a mobile device can be deployed on (e.g., in the operator compartment of) a mobile machine (e.g., mobile work machine 100) or can be communicably coupled to a mobile machine (e.g., mobile work machine 100) for use in generating, processing, or displaying the outputs (e.g., 360) discussed above. FIGS. 8 and 9 are examples of handheld or mobile devices.

FIG. 7 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, client system 24, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 8 shows one example in which device 16 is a tablet computer 1100. In FIG. 8, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 9 is similar to FIG. 8 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

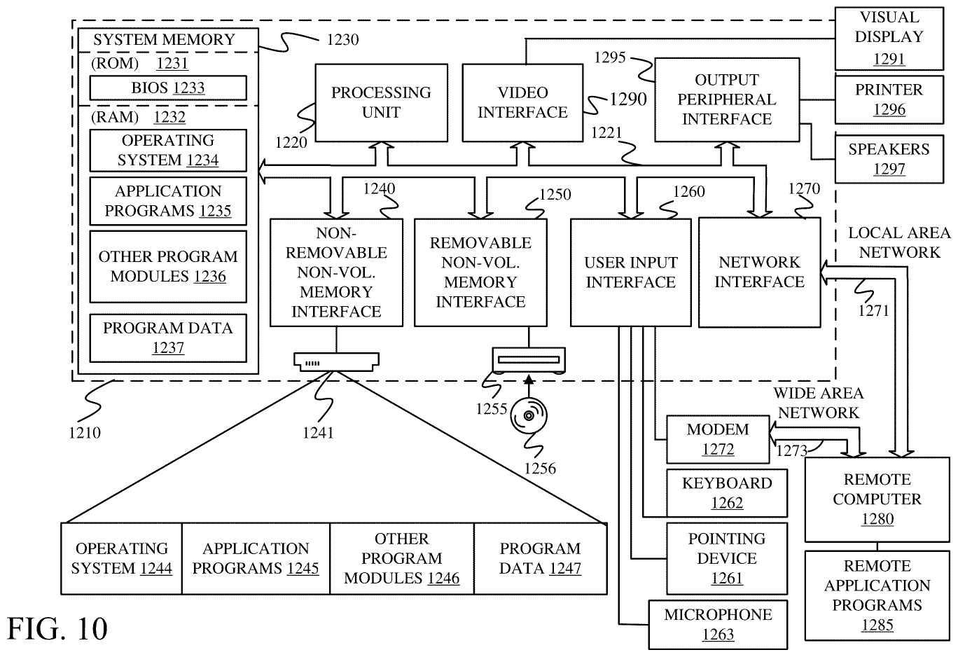

FIG. 10 is one example of a computing environment in which elements of previous figures described herein can be deployed. With reference to FIG. 10, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 10.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 10 illustrates operating system 1234, application programs 1235, other program modules 1236, and program data 1237.

The computer 1210 can also include other removable/non-removable volatile/nonvolatile computer storage media. By way of example only, FIG. 10 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 10, provide storage of computer readable instructions, data structures, program modules and other data for the computer 1210. In FIG. 10, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network-CAN, local area network-LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 10 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

1. (canceled)

2. A worksite operation system comprising:
one or more processors; and
memory storing instructions, executable by the one or more processors, that, when executed by the one or more processors, configure the one or more processors to:
track position data corresponding to a first set of one or more mobile work machines performing an operation at a worksite;
dynamically determine a passability status of each of one or more areas of the worksite based, at least, on the tracked position data corresponding to the first set of one or more mobile work machines;
generate a passability database based, at least, on the dynamically determined passability status of each of the one or more areas of the worksite; and
generate a respective route for each mobile work machine of a second set of one or more mobile work machines to traverse the worksite based, at least, on the passability database; and
control each mobile work machine of the second set of one or more mobile work machines based on the respective route for each mobile work machine of the second set of one or more mobile work machines.

3. The worksite operation system of claim 2, wherein the instructions, when executed by the one or more processors, further configure the one or more processors to:
generate a respective route for each mobile work machine of the first set of one or more mobile work machines to traverse the worksite based, at least, on the passability database and to control each mobile work machine of the first set of one or more mobile work machines based on the respective route for each mobile work machine of the first set of one or more mobile work machines.

4. The worksite operation system of claim 2, wherein the instructions, when executed by the one or more processors, further configure the one or more processors to:
perform filtering on the tracked position data corresponding to the first set of one or more mobile work machines to filter non-working tracked position data and to generate filtered tracked position data.

5. The worksite operation system of claim 4, wherein the instructions, when executed by the one or more processors, further configure the one or more processors to:
obtain one or more of heading sensor data or work occurrence sensor data and to perform the filtering based, at least, on the one or more of the heading sensor data or the work occurrence sensor data.

6. The worksite operation system of claim 2, wherein the passability database comprises a passability map of the worksite that maps passable and impassable areas of the worksite.

7. The worksite operation system of claim 2, wherein the instructions, when executed by the one or more processors, further configure the one or more processors to:
obtain preferences data indicative of one more input route generation preferences; and
generate the respective route for each mobile work machine of the second set of one or more mobile work machines to traverse the worksite based further on the preferences data.

8. The worksite operation system of claim 2, wherein the instructions, when executed by the one or more processors, further configure the one or more processors to:
obtain machine data indicative of one or more of machine ratings or machine dimensions for each mobile work machine of the second set of one or more mobile work machines; and
generate the respective route for each mobile work machine of the second set of one or more mobile work machines to traverse the worksite based further on the machine data.

9. The worksite operation system of claim 2, wherein the one or more mobile work machines of the first set of one or more mobile work machines are primary mobile work machines and wherein the one or more mobile work machines of the second set of one or more mobile work machines are support mobile work machines.

10. (canceled)

11. A computer implemented method comprising:
tracking position data corresponding to a first set of one or more mobile work machines performing an operation at a worksite;
dynamically determining a passability status of each of one or more areas of the worksite based, at least, on the tracked position data corresponding to the first set of one or more mobile work machines;
generating a passability database based, at least, on the dynamically determined passability status of each of the one or more areas of the worksite;
generating a respective route for each mobile work machine of a second set of one or more mobile work machines to traverse the worksite based, at least, on the passability database; and
controlling each mobile work machine of the second set of one or more mobile work machines based on the respective route for each mobile work machine of the second set of one or more mobile work machines.

12. The computer implemented method of claim 11 and further comprising:
performing filtering on the tracked position data corresponding to the first set of one or more mobile work machines to filter non-working tracked position data and to generate filtered tracked position data; and
wherein dynamically determining the passability status of each of the one or more areas of the worksite comprises determining the passability status of each of the one or more areas of the worksite based on the filtered tracked position data.

13. The computer implemented method of claim 12 and further comprising:
obtain one or more of heading sensor data or work occurrence sensor data; and
wherein performing filtering on the tracked position data corresponding to the first set of one or more mobile work machines comprises performing filtering on the tracked position data corresponding to the first set of one or more mobile work machines based, at least, on the one or more of the heading sensor data or the work occurrence sensor data.

14. The computer implemented method of claim 13, wherein performing filtering on the tracked position data corresponding to the first set of one or more mobile work machines comprises identifying the non-working tracked position data based, at least, on the one or more of the heading sensor data or the work occurrence sensor data.

15. The computer implemented method of claim 11 and further comprising:
obtaining preferences data indicative of one more input route generation preferences; and
wherein generating the respective route for each mobile work machine of the second set of one or more mobile work machines to traverse the worksite comprises generating the respective route for each mobile work machine of the second set of one or more mobile work machines to traverse the worksite based further on the preferences data.

16. The computer implemented method of claim 11 and further comprising:
obtain machine data indicative of one or more of machine ratings or machine dimensions for each mobile work machine of the second set of one or more mobile work machines; and
wherein generating the respective route for each mobile work machine of the second set of one or more mobile work machines to traverse the worksite comprises generating the respective route for each mobile work machine of the second set of one or more mobile work machines to traverse the worksite based further on the machine data.

17. A worksite operation system comprising:
one or more processors; and
memory storing instructions, executable by the one or more processors, that, when executed by the one or more processors, configure the one or more processors to:
tracking position data corresponding to a first mobile work machine performing an operation at a worksite;
dynamically determine a passability status of each of one or more areas of the worksite based, at least, on the tracked position data corresponding to the first mobile work machine;
generate a route for a second mobile work machine to traverse the worksite based, at least, on the dynamically determined passability status of each of the one or more areas of the worksite; and
control the second mobile work machine based on the route.

18. The worksite operation system of claim 17, wherein the instructions, when executed by the one or more processors, further configure the one or more processors to:
filter the tracked position data to filter out non-working tracked position data based on sensor data indicating whether the first mobile work machine was working to generate filtered tracked position data; and
dynamically determine the passability status of each of the one or more areas of the worksite based, at least, on the tracked position data.

19. The worksite operation system of claim 17, wherein the instructions, when executed by the one or more processors, further configure the one or more processors to:
obtain data indicative of one or more of a type of the first mobile work machine or a type of the operation; and
dynamically determine the passability status of each of the one or more areas of the worksite based further on the data indicative of the one or more of the type of the first mobile work machine or the type of the operation.

20. The worksite operation system of claim 17, wherein the instructions, when executed by the one or more processors, further configure the one or more processors to:
obtain one or more of preferences data indicative of one more input route generation preferences or machine data indicative of one or more of machine ratings or machine dimensions for the second mobile work machine;
generate the route for the second mobile work machine to traverse the worksite based further on the one or more of the preferences data or the machine data.

21. The worksite operation system of claim 2, wherein the passability status is dynamically determined based on at least one of:
a machine type of the first set of one or more mobile work machines performing the operation at the worksite, or
an operation type of the operation at the worksite.

22. The worksite operation system of claim 6, wherein each respective area, of a plurality of areas of the worksite, are identified in the passability map as being a passable area or an impassable area based on determining whether the respective area is covered by the first set of one or more mobile work machines.
